(19) United States
(12) Patent Application Publication
(10) Pub. No.: US 2026/0054656 A1
(43) Pub. Date: Feb. 26, 2026

(54) FOLDABLE AND LOCKABLE GOLF CART RACK

(71) Applicant: Gerard Capron, Summerville, SC (US)

(72) Inventor: Gerard Capron, Summerville, SC (US)

(21) Appl. No.: 19/378,456

(22) Filed: Nov. 4, 2025

Related U.S. Application Data
(63) Continuation of application No. 18/420,309, filed on Jan. 23, 2024, now Pat. No. 12,466,328.

(51) Int. Cl. B60R 9/06

(52) U.S. Cl. CPC B60R 9/06

(57) ABSTRACT

A foldable and lockable golf cart rack that extends from a rear seat grab bar of a golf cart. A pair of foldable rack members extend generally horizontally from the support members, and are secured relative to vertical support members by a locking device. The rack members are rotatable relative to a pivot point by disabling the locking device. The rack members are pivoted to so as to be positioned and secured in a second configuration by a retainer that is located below the pivot point.

This application is a Continuation of application Ser. No. 18/420,309, filed Jan. 23, 2024, the benefit of which is claimed hereby.

### BACKGROUND FOR THE INVENTION

Golf carts are increasingly used as transportation for people and objects as the use of electric vehicles increases. This use of golf carts has little or nothing to do with the game of golf, and therefore, “golf cart” is a misnomer for the device as used for human transportation on streets. However, the term “golf cart” remains in widespread use to describe these vehicles, and is used herein. Not all golf carts are electric, and the use of the invention described herein is not limited to electric golf carts.

Golf carts are commonly used for short range transportation in subdivisions and housing communities. Golf carts of this type and use have a rear seat for occupants in addition to the front seat found in golf carts used on golf courses. The rear seat typically has a grab bar for the rear seat occupants to hold. The rear seat grab bar comprises two spaced apart and parallel vertical members connected by an upper connecting member or portion. The rear seat grab bar is usually mounted at the extreme rear of the golf cart.

Golf carts for transportation are used to transport objects in addition to people. However, golf carts with rear seats have limited space for transporting objects. For example, users of the golf cart may transport lawn chairs, bags with handles, or other objects for use upon arrival at a destination, such as a pool or a beach. There is a need for a golf cart rack that increases the hauling capacity of the golf cart, with the rack capable of being folded out of the way when not in use.

### SUMMARY OF THE INVENTION

The present invention is a foldable and lockable golf cart rack that extends from a rear seat grab bar of a golf cart. A pair of foldable rack members extend generally horizontally from the support members, and are secured in position relative to vertical support members by a locking device. The rack members are rotatable about a pivot point by disabling the locking device. The rack members may be pivoted so as to be positioned and secured in a second configuration by a retainer that is located below the pivot point.

### BRIEF DRAWING DESCRIPTION

FIG. 1 shows the foldable and lockable golf cart rack folded and secured when not in position for use in transporting objects.

FIG. 2 shows the foldable and lockable golf cart extended for use in transporting objects.

FIG. 3A shows assembled elements of the foldable and lockable golf cart rack positioned generally horizontally for use and telescoped to reduce its length.

FIG. 3B shows assembled elements of the foldable and lockable golf cart rack positioned generally horizontally and extended to expand its length.

FIG. 3C shows assembled elements of the foldable and lockable golf cart rack folded away and positioned generally vertically.

### DESCRIPTION OF PREFERRED EMBODIMENTS

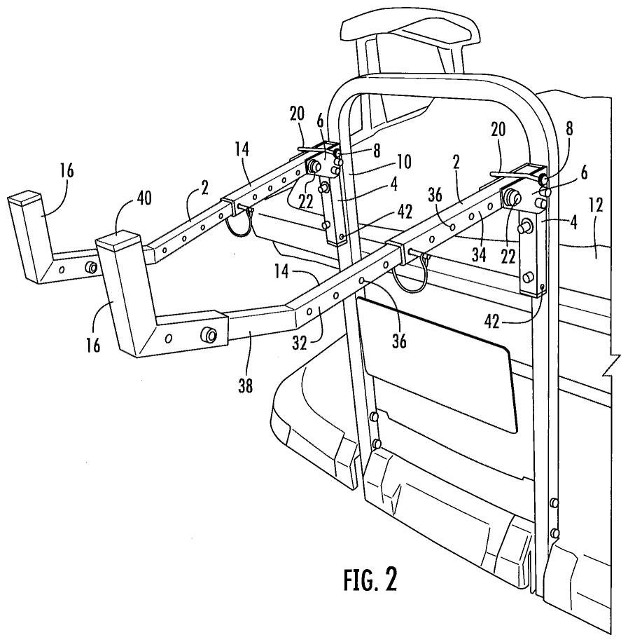

FIG. 2 shows the foldable and lockable golf cart rack in position for use in transporting objects by the golf cart. A pair of rack members 2 extend away from a rear seat 24 grab bar 10 of a golf cart 12. Each rack member in the configuration shown comprises a generally horizonal portion 14 and an upwardly extending portion 16 at a distal end of the rack member in this configuration, and in position for use in carrying objects. The rack members are spaced apart and are generally parallel to each other as shown in FIG. 2.

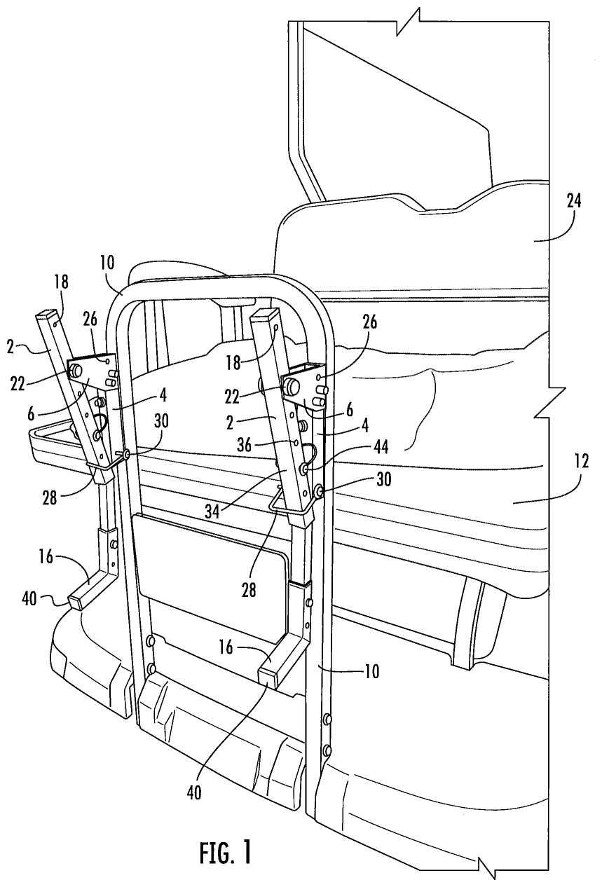

The rack members 2 are mounted to the rear seat grab bar 10 of the golf cart. As shown in the drawings, the rack members are attached to vertical support members 4 that are constructed and arranged for mounting to the rear seat grab bar. The support members are positioned generally vertically on the rear seat grab bar in the embodiment shown in the drawings. Outwardly extending arms 6 are mounted to the vertical support members and connect the vertical support members to the rack members. The rack members are mounted to the vertical support members by a pivot point 22 on the arms 6 that allows the rack members to rotate from the position shown in FIG. 1 to the position shown in FIG. 2. Proximal ends of the rack members are positioned within the arms of the support members when the foldable and lockable golf cart rack is in the position shown in FIG. 2.

An embodiment of a locking device is shown in FIG. 2. A locking pin 8 is inserted through a void 26 formed in the arms 6 and through a void 18 in the proximal end of each rack member 2 to hold the foldable and lockable golf cart rack in the horizontal position shown in FIG. 2. The pins are preferred to have a bail 20 or a cotter pin or similar object to hold the pins in place while the foldable and lockable golf cart rack is in the generally horizontal position and in use. Locking pins 8 are preferred to be inserted into the rack members and arms between the pivot point and the proximal end of the rack members to lock the rack members in the generally horizontal position.

The rear seat grab bar 10 may be manufactured to incorporate or provide for the arms 6 that provide functioning of the foldable rack members 2 as disclosed herein, rather than having separate vertical support members 4. As shown in the drawings, the vertical support members are separate parts that are affixed to rear seat grab bars that are currently known and in use. In another embodiment, the arms may be mounted directly to the rear seat grab bars. The vertical portion of the rear seat grab bars are the vertical support members in the another embodiment.

The term “proximal” as used herein means the end of the rack members 2 closest to the rear of the golf cart 12, and the term “distal” means the opposite end of the rack members that are furthest from the rear of the golf cart when the rack members are in the generally horizontal position as shown in FIG. 2.

As shown in FIG. 1, the rack members 2 are rotated about pivot point 22 so that the rack members do not extend materially outward from the golf cart. The positioning of the foldable and lockable golf cart rack as shown in FIG. 1 is described herein as the rack members being positioned generally vertically. The rack members as shown in FIG. 2 are referred to herein as being positioned generally horizontally. Folding and securing the rack members to the generally vertical position prevents the rack members from extending materially beyond the rear of the golf cart so that the rack members are less likely to strike other objects or be struck by other objects, since the rack members are less visible when not carrying beach chairs or other objects.

The rack members 2 shown in the position of FIG. 1 are locked or secured in the vertical position. A retainer holds the rack members in the vertical position. The retainer as shown in FIG. 1 is bail 28 that extends from a first end of pin 30 and is removably attached to the opposite end of the pin. The locking pin is inserted through void 42 in the vertical support member 4 when the rack members are positioned vertically, so that a bail surrounds each rack member. The opposite end of the bail is connected to the opposite end of the pin. The locking pin and bail retain the rack member and foldable and lockable golf cart rack in place in the vertical position, especially as the golf cart travels over bumps and other obstacles. The same pin and bail construct may be used as part of the locking device for holding the rack members within the arms 6 and in the horizontal position as described herein.

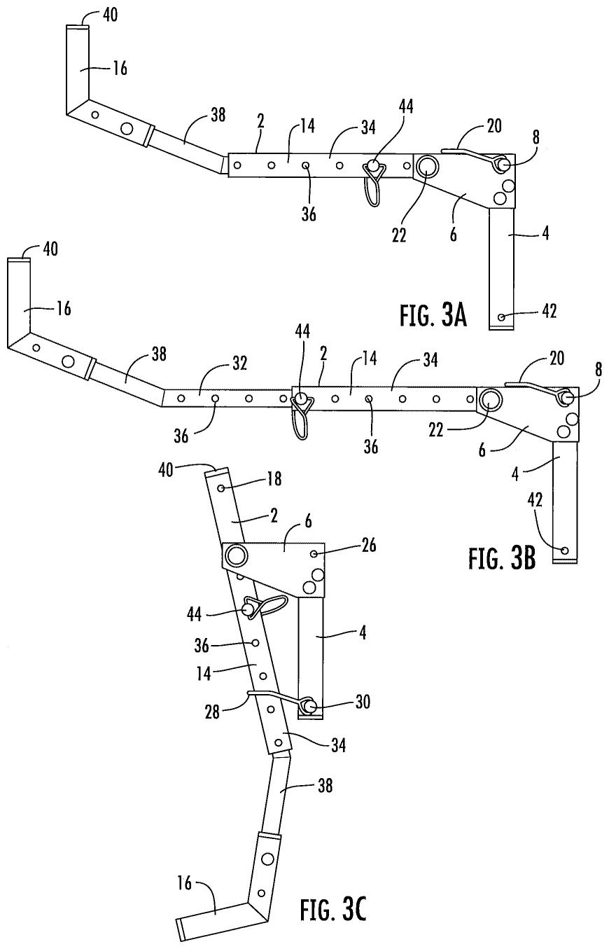

As shown in FIG. 3A, each rack member 2 has a generally horizontal portion 14 that preferably extends along a majority of the length of the rack member. However, the horizontal portion of the rack member is preferred to be length adjustable. The horizontal portion of the rack member may be contracted as shown in FIG. 3A, or expanded as shown in FIG. 3B. In the embodiment shown, an internal member 32 and an external member 34 of the rack member slidably engage in a telescoping manner. A series of voids 36 is provided in at least the internal member. A void in the external member receives a pin 44 that extends through one of the voids in the internal member after a preferred length of the rack member is determined by the user. The plurality of voids provide selectability in establishing the desired length of the rack member.

The rack members 2 have an upturned portion 16 at the distal end of the rack members in the embodiment shown in FIGS. 3A and 3B. The upturned portion inhibits articles that are positioned on the rack members, such as lawn chairs or beach chairs, from sliding off of the foldable and lockable golf cart rack as the golf cart travels.

The foldable and lockable golf cart rack is particularly well suited for transporting objects like beach chairs, bags with straps and other articles that have a member that can be hung from one or both of the rack members. For example, beach chairs typically comprise a connecting member that connects a first vertical member or leg to a second vertical member or leg of the beach chair. This connecting member is positioned over both of the rack members 2 of the pair of rack members to transport the beach chair.

The rack members 2 may have a dogleg portion 38. The dogleg portion is an upwardly sloping portion of the rack members between the generally horizontal portion 14 of the rack members and the upwardly turned portion 16 of the rack members. FIG. 2. The dogleg portion assists in retaining articles on the foldable and lockable golf cart rack. The dogleg portion also helps is loading articles onto the rack members. As articles are lifted over the upturned portion and placed on the dogleg portion, the articles to be transported by the golf cart will tend to slide down and toward the generally horizontal portion of the rack member.

Resilient inserts 40 formed of polymers or other plastics, or rubber, may be positioned in one or both ends of the tubes from which the rack members 2 are constructed. Resilient members that act as stops may be placed within the arms against which the rack members rest when the rack members are in the horizontal position.

FIG. 3C shows a rack member secured by the retainer 28. The rack member 2 is unlocked from the horizontal position and held in the vertical position in this view.

What is claimed:

1. A cargo rack assembly for a golf cart, comprising:
a pivot arm pair, each arm projecting rearward from a corresponding vertical support member mounted to the golf cart;
a rack member pair, each rack member being pivotally coupled to a corresponding one of the pivot arm pair about a horizontal axis and being movable between a generally horizontal, load-carrying orientation and a generally vertical, stowed orientation;
a locking device associated with each of the pivot arm pair and configured to releasably secure the corresponding one of the rack member pair in the horizontal orientation; and
a retainer device located below the horizontal axis and configured to releasably secure each of the rack member pair in the vertical orientation;
wherein an upturned distal portion of each rack member of the rack member pair extend above the pivot arm pair.

2. The cargo rack assembly of claim 1, wherein a length adjustment pin fixes discrete extension positions of the rack member, and the length adjustment pin comprises a ball-detent quick-release pin captively retained to the rack member to prevent loss during use.

3. The cargo rack assembly of claim 1, further comprising a dogleg portion positioned between a horizontal portion of each rack member and the upturned distal portion.

4. The cargo rack assembly of claim 3, wherein the upturned distal portion defines a cargo-retention stop and is terminated by an end cap formed of a resilient material.

5. The cargo rack assembly of claim 1, wherein the vertical support members are incorporated into a rear set grab bar.

6. The cargo rack assembly of claim 1, wherein a telescoping mechanism is incorporated into each rack member.

7. The cargo rack assembly of claim 1, wherein the vertical support members and the pivot arm pair are integrated into a rear-seat grab bar as an integrated grab-bar support that incorporates pivot axes and retainer locations directly into the grab bar.

8. The cargo rack assembly of claim 1, wherein an external tube segment and an internal tube segment comprise square-section tubing configured to resist torsional twist within a telescoping mechanism incorporated into each rack member.

9. A cargo rack assembly for a golf cart, comprising:
a generally vertical support having pivot mounts and retainer mounts formed integrally therewith;
a rack member pair pivotally supported by the pivot mounts for movement between horizontal and vertical orientations;
a latch-based lock comprising a spring-loaded latch at each pivot mount that automatically engages the corresponding rack member in the horizontal orientation; and
a spring-loaded latch or an over-center cam located at each retainer mount and configured to secure the corresponding rack member in the vertical orientation.

10. The cargo rack assembly of claim 9, wherein each spring-loaded latch comprises an ergonomic pull ring configured to provide single-handed release.

11. The cargo rack assembly of claim 9, wherein the latch-based lock and the telescoping mechanism each utilize captive detent pins to eliminate loose hardware.

12. The cargo rack assembly of claim 9, further comprising a dogleg portion and an upturned distal portion, the upturned distal portion being at an angle relative to a horizontal portion.

13. The cargo rack assembly of claim 9, further comprising a telescoping mechanism within each rack member providing selectable length adjustment.

14. A method of configuring a golf-cart cargo rack, the method comprising:
pivoting a rack member pair from a vertical, stowed orientation to a horizontal, load-carrying orientation about a set of pivot mounts on a golf cart to extend from a rear of the golf cart.
inserting a locking device through aligned apertures in each one of the set of pivot mounts and in a corresponding rack member to secure the rack member pair in the horizontal orientation;
adjusting a telescoping mechanism in each rack member by aligning apertures in the internal tube segment and the external tube segment and inserting a length adjustment pin to achieve a desired rack length.

15. The method of claim 14, wherein the locking device and the length adjustment pin each comprise ball-detent quick-release pins that remain captive to prevent loss, and wherein a retainer device comprises a ball-detent quick-release pin that remains captive to prevent loss.

16. The method of claim 14, further comprising withdrawing the locking device, rotating the rack member pair to the vertical orientation, and engaging a retainer device below the set of pivot mounts to immobilize the rack member pair during vehicle travel.

17. The method of claim 14, wherein a spring-loaded latch automatically engages at least one rack member of the rack member pair in at least one of the horizontal or vertical orientations without removal of hardware.

18. The method of claim 14, further comprising loading cargo onto the rack member pair such that a dogleg portion guides the cargo toward the golf cart and an upturned distal portion prevents sliding loss.

19. The method of claim 14, wherein the set of pivot mounts and retainer device are formed integrally with a rear-seat grab bar as an integrated grab-bar support.
